(19) United States
(12) Patent Application Publication
(10) Pub. No.: US 2010/0309214 A1
(43) Pub. Date: Dec. 9, 2010

(54) LIGHT EMITTING DEVICE AND METHOD OF DRIVING THE SAME

(76) Inventor: Duck-Gu Cho, Suwon-si (KR)

Correspondence Address: CHRISTIE, PARKER & HALE, LLP, PO BOX 7068, PASADENA, CA, 91109-7068, US

(21) Appl. No.: 12/629,837

(22) Filed: Dec. 2, 2009

(30) Foreign Application Priority Data
Jun. 8, 2009 (KR) 10-2009-0050482

(51) Int. Cl. H04N 5/00; G09G 5/02; G09G 5/00

(52) U.S. Cl. 345/589; 348/699; 348/E05.001; 345/214

(57) ABSTRACT

A light emitting device and a method of driving the same that can reduce or even prevent motion blur and flicker phenomena. The light emitting device includes: a display unit including scan lines, column lines, and light emitting pixels configured to provide light to at least one pixel of the display device; a partial brightness controller configured to read the input video signal and the input image control signal, to generate a brightness information signal having brightness information of each of the light emitting pixels, and to generate a motion detection signal having motion information of the entire display device for a frame; and a controller configured to control a pulse width ratio between a first scan signal and a second scan signal, applied to each of the scan lines for the frame, according to the motion detection signal.

### CROSS-REFERENCE TO RELATED APPLICATION

This application claims priority to and the benefit of Korean Patent Application No. 10-2009-0050482, filed in the Korean Intellectual Property Office on Jun. 8, 2009, the entire contents of which are incorporated herein by reference.

### BACKGROUND

1. Field of the Invention

The following description relates generally to a light emitting device and a method of driving the same. More particularly, the following description relates generally to a light emitting device that emits light using electron emission characteristics due to an electric field, and a method of driving the same.

2. Description of the Related Art

A liquid crystal display (LCD), which is a flat panel display, is a display device that displays an image by changing a light transmission amount on a pixel using dielectric anisotropy of liquid crystal having a changing twist angle according to an applied voltage. Compared with a cathode ray tube, which is a typical image display device, the LCD is lighter in weight and thinner in thickness, and consumes less power. The LCD includes a liquid crystal panel assembly and a light emitting device that is positioned at a rear side of the liquid crystal panel assembly to provide light to the liquid crystal panel assembly.

When the liquid crystal panel assembly is formed with an active liquid crystal panel assembly, the liquid crystal panel assembly includes a pair of transparent substrates, a liquid crystal layer that is positioned between the transparent substrates, a polarizing plate that is disposed at an outer surface of the transparent substrates, a common electrode that is provided in an inside surface of one of the transparent substrates, pixel electrodes and switches that are provided in an inside surface of the other one of the transparent substrates, and a color filter that provides red, green, and blue colors to three sub-pixels constituting a pixel. The liquid crystal panel assembly receives light that is emitted from a light emitting device, and embodies an image (e.g., a predetermined image) by transmitting or blocking the light with action of the liquid crystal layer.

As a light source of the light emitting device, a fluorescent lamp of a structure forming a surface light source having uniform brightness is used. The fluorescent lamp uses a cold cathode fluorescent lamp (CCFL) that can emit light with a high luminance while having a small size. In a light emitting device using a cold cathode fluorescent lamp, because light sources are always turned on, a flicker phenomenon in which a screen flickers does not occur. However, in an image having a fast motion, a motion blur phenomenon in which a dim after-image is displayed on a screen may occur. In order to improve the problem, as a light source of the light emitting device, an electron emission element is used and an impulsive scanning driving method is selected. As in a cathode ray tube, the electron emission element has a merit of being operated by cathode electrode line light emission and having a fast operation speed and a wide operation temperature range. Particularly, as the electron emission element, a carbon nanotube (CNT) having good light emitting efficiency is used. An impulsive scanning driving method is a method of turning on light sources of a light emitting device at a time point at which an image is displayed for one frame, and turning off light sources for the remaining period. In such a method, because an after-image of a previous frame can be removed, a motion blur phenomenon can be improved. However, in a still image that does not result in an abrupt change of a screen, there is a problem that a flicker phenomenon occurs, as in a cathode ray tube.

The above information disclosed in this Background section is only for enhancement of understanding of the background of the described technology and therefore it may contain information that does not form the prior art that is already known in this country to a person of ordinary skill in the art.

### SUMMARY

Aspects of embodiments of the present invention are directed toward a light emitting device and a method of driving the same capable of reducing or even preventing motion blur and flicker phenomena.

An exemplary embodiment provides a light emitting device configured as a light source for a display device that displays an image according to an input video signal and an input image control signal. The light emitting device includes: a display unit including a plurality of scan lines, a plurality of column lines, and a plurality of light emitting pixels configured to provide light to at least one pixel of the display device; a partial brightness controller configured to read the input video signal and the input image control signal, to generate a brightness information signal having brightness information of each of the plurality of light emitting pixels, and to generate a motion detection signal having motion information of the entire display device for a frame; and a controller configured to control a pulse width ratio between a first scan signal and a second scan signal, applied to each of the plurality of scan lines for the frame, according to the motion detection signal.

In one embodiment, the partial brightness controller is configured to generate the motion detection signal with different values according to whether the input video signal is for a still picture or a motion picture. In one embodiment, the partial brightness controller is configured to generate the motion detection signal with different values according to a motion degree of the motion picture when the input video signal is for the motion picture. In one embodiment, the controller is configured to control a pulse width of the first scan signal to be substantially identical to a pulse width of the second scan signal when the input video signal is for the still picture. In one embodiment, the controller is configured to control a pulse width of the first scan signal to be larger than a pulse width of the second scan signal when the input video signal is for the motion picture. In one embodiment, the controller is configured to control the pulse width of the first scan signal to sequentially increase according to a motion degree of the motion picture.

In one embodiment, the controller is configured to divide the brightness information signal into a first division brightness information signal and a second division brightness information signal according to the motion detection signal, and to generate a light emitting signal. In one embodiment, the controller is configured to control a division ratio between the first and second division brightness information signals to be substantially identical to the pulse width ratio between the first and second scan signals.

Another exemplary embodiment provides a method of driving a light emitting device including a plurality of light emitting pixels, a plurality of scan lines, and a plurality of column lines, the light emitting device being configured as a light source for at least one pixel of a display device for displaying an image according to an input video signal and an input image control signal. The method includes: generating a motion detection signal having motion information of the entire display device for a frame; controlling a pulse width ratio between a first scan signal and a second scan signal according to the motion detection signal; and applying the controlled pulse width ratio between the first and second scan signals to each of the plurality of scan lines for the frame.

In one embodiment, the generating of the motion detection signal includes generating the motion detection signal with different values according to whether the input video signal is for a still picture or a motion picture. In one embodiment, the generating of the motion detection signal includes generating, when the input video signal is for the motion picture, the motion detection signal with different values according to a motion degree of the motion picture. In one embodiment, the controlling of the pulse width ratio between the first and second scan signals includes forming a pulse width ratio of the first scan signal to be substantially identical to the second scan signal when the input video signal is for the still picture. In one embodiment, the controlling of the pulse width ratio between the first and second scan signals includes increasing a pulse width of the first scan signal to be larger than that of the second scan signal when the input video signal is for the motion picture. In one embodiment, the controlling of the pulse width ratio between the first and second scan signals includes sequentially increasing the pulse width of the first scan signal according to a motion degree of the motion picture.

In one embodiment, the method further includes: generating a brightness information signal having brightness information of each of the plurality of light emitting pixels by reading the input video signal and the input image control signal; and dividing the brightness information signal into a first divisional brightness information signal and a second division brightness information signal according to the motion detection signal. In one embodiment, the dividing of the brightness information signal into the first and second division brightness information signals includes forming a division ratio between the first and second division brightness information signals to be substantially identical to the pulse width ratio between the first and second scan signals.

As described above, according to embodiments of the present invention, by applying a dual scanning method and adjusting a time interval of a scanning pulse according to a motion of an image being displayed, motion blur and flicker phenomena can be reduced or even prevented.

### BRIEF DESCRIPTION OF THE DRAWINGS

FIG. 1 is a block diagram illustrating a configuration of an LCD according to an exemplary embodiment.

FIG. 2 is an equivalent circuit diagram of a pixel PX that is shown in FIG. 1.

FIG. 3 is a diagram illustrating a scan signal that is supplied to a plurality of scan lines S1-Sp according to an exemplary embodiment.

### DETAILED DESCRIPTION

In the following detailed description, certain exemplary embodiments have been shown and described, simply by way of illustration. As those skilled in the art would realize, the described embodiments may be modified in various different ways, all without departing from the spirit or scope of the embodiment. Accordingly, the drawings and description are to be regarded as illustrative in nature and not restrictive. Like reference numerals designate like elements throughout the specification.

Throughout this specification and the claims that follow, when it is described that an element is “coupled” or “connected” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

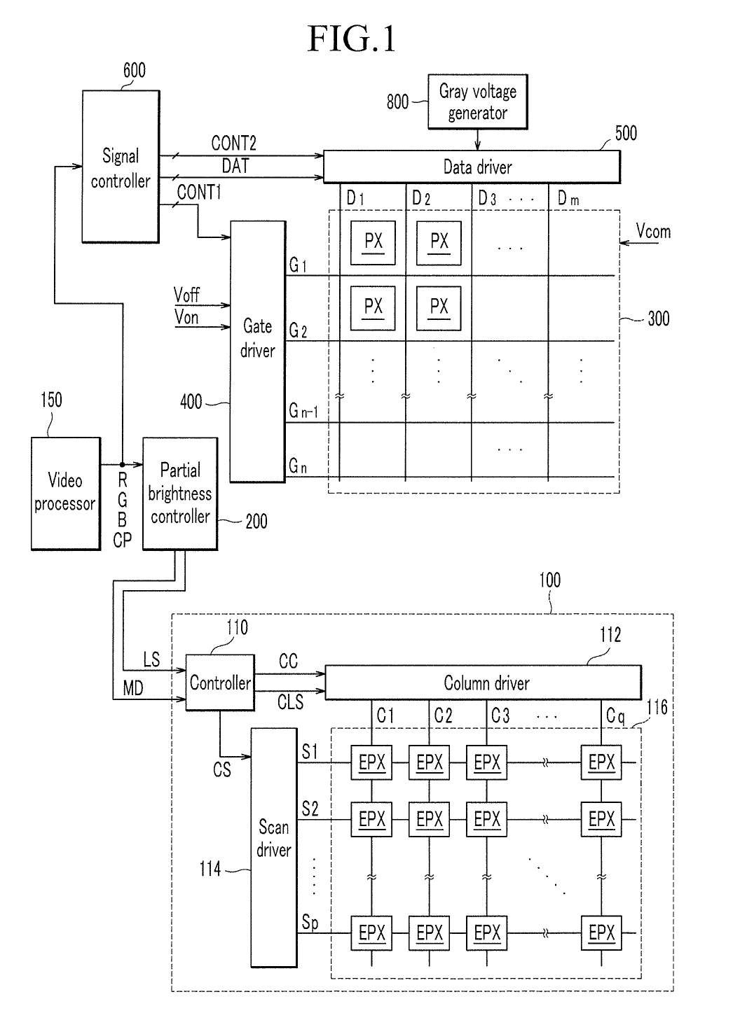

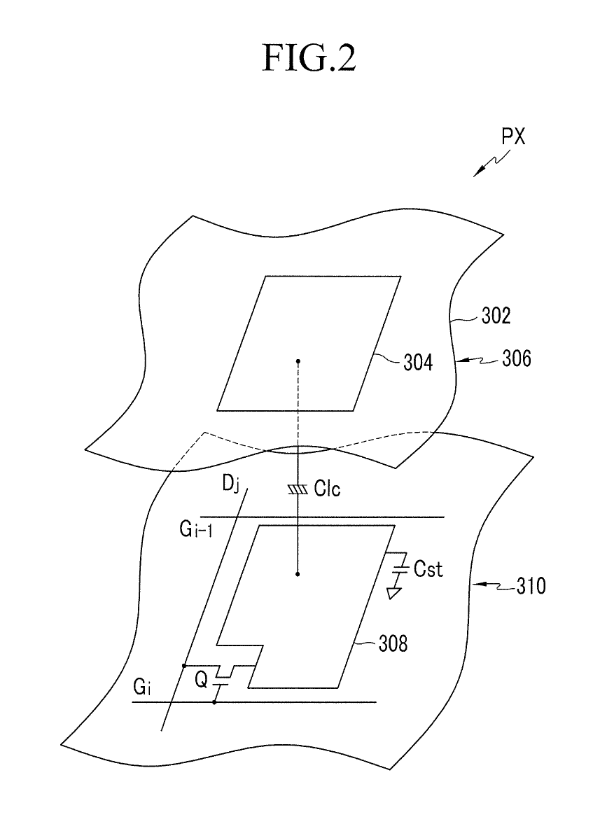

FIG. 1 is a block diagram illustrating a configuration of an LCD according to an exemplary embodiment, and FIG. 2 is an equivalent circuit diagram of a pixel PX that is shown in FIG. 1.

Referring to FIG. 1, the LCD according to the present exemplary embodiment includes a light emitting device 100, a video processor 150, a partial brightness controller 200, a liquid crystal panel assembly 300, a gate driver 400, a data driver 500, a signal controller 600, and a gray voltage generator 800.

The video processor 150 receives an image source that is transmitted from various media to convert the image source to an input image control signal CP that displays an image according to input video signals R, G, and B, and an input image corresponding to a resolution of an LCD. The generated input video signals R, G, and B and input image control signal CP are input to the partial brightness controller 200 and the signal controller 600. The input video signals R, G, and B include luminance information of each pixel PX, and the luminance has grays (or gray levels) of a determined number, for example, 1024 (=2¹⁰), 256 (=2⁸), or 64 (=2⁶). The input image control signal CP includes input video signals R, G, and B and control signals Hsync, Vsync, MCLK, and DE that are necessary for displaying the input video signals R, G, and B.

The partial brightness controller 200 receives the input video signals R, G, and B and the input image control signal CP and outputs a brightness information signal LS and a motion detection signal MD. The partial brightness controller 200 reads the input video signals R, G, and B and the input image control signal CP, and generates a brightness information signal LS that arranges a plurality of brightness data representing brightness information of each of a plurality of light emitting pixels EXP of the light emitting device 100. Specifically, the partial brightness controller 200 reads the input video signals R, G, and B and the input image control signal CP, detects a highest gray (or a highest gray level) of a plurality of pixels PX corresponding to a light emitting pixel EXP of the light emitting device 100, and determines a gray (or a gray level) of the corresponding light emitting pixel EXP according to the detected gray (or the detected gray level). The partial brightness controller 200 generates brightness information signal LS representing the determined gray (or the determined gray level).

Further, the partial brightness controller 200 reads the input video signals R, G, and B and the input image control signal CP, extracts a motion degree of a plurality of the entire pixels PX of the liquid crystal panel assembly 300 in units of a frame, and generates a motion detection signal MD. The partial brightness controller 200 generates the motion detection signal MD with different levels according to luminance of the input video signals R, G, and B. The motion detection signal MD adjusts a light emitting period of a plurality of light emitting pixels EPX for a frame to correspond to a motion of the input video signals R, G, and B. In the present exemplary embodiment, when the input video signals R, G, and B are for a still picture having no motion, a plurality of light emitting pixels EPX emit light for an entire frame, thereby reducing or even preventing a flicker phenomenon. Alternatively, when the input video signals R, G, and B are for a motion picture having motion, a plurality of light emitting pixels EPX emit light at only an initial stage of a frame, thereby preventing a motion blur phenomenon. For this reason, the motion detection signal MD determines a ratio of a pulse width of a first scan signal to an entire pulse width of a scan signal.

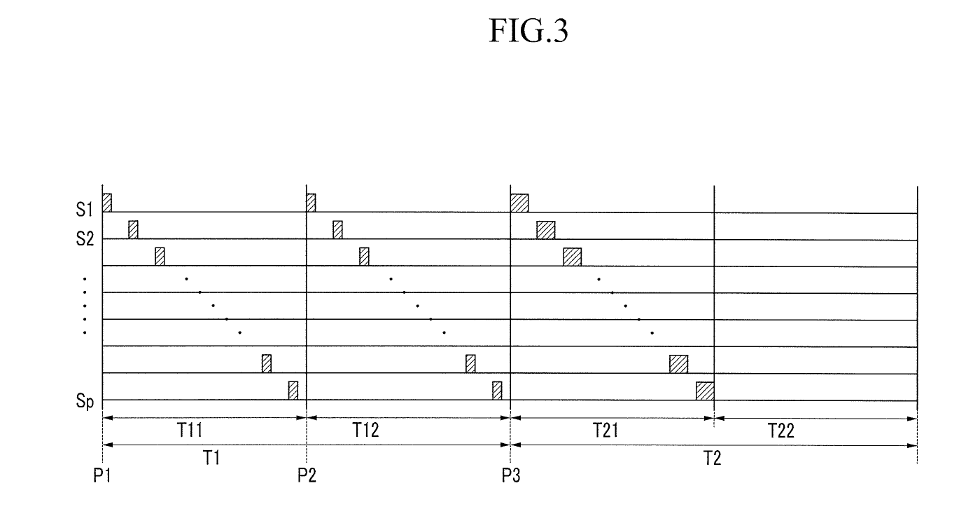

Here, in the present exemplary embodiment, a dual scanning method of applying a scan signal two times to each of a plurality of scan lines S1-Sp to dual-scan each for a frame period is applied. A frame is divided into first and second fields by a dual scanning method. The first field is a period in which a first scan signal is applied to each of a plurality of scan lines S1-Sp, and the second field is a period in which a second scan signal is applied to each of a plurality of scan lines S1-Sp. A detailed description thereof is given later with reference to FIG. 3.

The motion detection signal MD according to the present exemplary embodiment is embodied with digital data having a bit that can represent a change in luminance of the input video signals R, G, and B with a level. For example, if the motion detection signal MD is ‘000’ when the input video signals R, G, and B are for a still picture having no motion, then in a motion picture having motion that is greater by 10% than that of the still picture, the motion detection signal MD becomes ‘001’. Likewise, in a motion picture having a motion greater by 20% than that of the still picture, the motion detection signal MD becomes ‘010’. That is, the motion detection signal MD is changed to ‘000’, ‘001’, ‘010’, ‘011’, ‘100’, ‘101’, and ‘110 ’ according to a motion degree based on a still picture. Here, the bit number of the motion detection signal MD is adjusted according to a unit determining a pulse width ratio between a first scan signal and a second scan signal. The present exemplary embodiment illustrates a case where a pulse width ratio between a first scan signal and a second scan signal increases and decreases in units of 10%. Accordingly, in the present exemplary embodiment, the motion detection signal MD is embodied with 3 bits, however the embodiment is not limited thereto.

The liquid crystal panel assembly 300 includes a plurality of signal lines G1-Gn and D1-Dm and a plurality of pixels PX that are connected thereto and that are arranged in substantially a matrix form, from an equivalent circuit view. The signal lines G1-Gn and D1-Dm include a plurality of gate lines G1-Gn that transfer a gate signal (hereinafter, may be referred to as a “scan signal”) and a plurality of data lines D1-Dm that transfer a data voltage. The gate lines G1-Gn extend in substantially a row direction and are substantially parallel to each other, and the data lines D1-Dm extend in substantially a column direction and are substantially parallel to each other.

Referring to FIG. 2, each pixel PX, for example, a pixel PXij that is connected to an i-th (i=1, 2, n) gate line Gi and a j-th (j=1, 2, m) data line Dj, includes a switch Q that is connected to signal lines Gi and Dj and a liquid crystal capacitor Clc and a storage capacitor Cst that are connected to the switch Q. The storage capacitor Cst may be omitted, as needed.

The switch Q is a three terminal element such as a thin film transistor that is provided in a lower display panel 310, and a control terminal thereof is connected to the gate line Gi, an input terminal thereof is connected to the data line Dj, and an output terminal thereof is connected to the liquid crystal capacitor Clc and the storage capacitor Cst.

The liquid crystal capacitor Clc uses a pixel electrode 308 of the lower display panel 310 and a common electrode 302 of an upper display panel 306 as two terminals, and there is a liquid crystal layer between the two electrodes 302 and 308.

The pixel electrode 308 is connected to the switch Q, and the common electrode 302 is formed in a front surface of the upper display panel 306 and receives a common voltage Vcom. Unlike a case of FIG. 2, the common electrode 302 may be provided in the lower display panel 310, and in this case, at least one of the two electrodes 302 and 308 may be formed in a linear shape or a bar shape.

The sustain capacitor Cst that performs a function as an assistant of the liquid crystal capacitor Clc is formed by overlapping a separate signal line and the pixel electrode 308 that are provided in the lower display panel 310 with an insulator therebetween, and a voltage (or a predetermined voltage) such as a common voltage Vcom is applied to the separate signal line. However, the storage capacitor Cst may be formed by overlapping the pixel electrode 308 with a front end gate line Gi−1 directly on the pixel electrode 308 using an insulator as an intermediary.

In order to embody color display in which each pixel PX inherently displays one of a plurality of primary colors (spatial division), or in which each pixel PX sequentially and alternately displays a plurality of primary colors (temporal division), a desired color can be recognized with a spatial or temporal combination of the primary colors. The primary colors may include, for example, three primary colors of light, such as red, green, and blue colors. FIG. 2 illustrates an example of a spatial division, and shows that each pixel PX has a color filter 304 representing one of primary colors in an area of the upper display panel 306 corresponding to the pixel electrode 308. The present invention, however, is not thereby limited, and the color filter 304 may be disposed in an upper part or a lower part of the pixel electrode 308 of the lower display panel 310. At least one polarizer is also provided in the liquid crystal panel assembly 300.

Referring again to FIG. 1, the gray voltage generator 800 generates all gray voltages or gray voltages of a limited number (hereinafter referred to as a “reference gray voltages”) that are related to transmittance of the pixel PX. The reference gray voltages may have a positive value and/or a negative value relative to a common voltage Vcom.

The gate driver 400 is connected to gate lines G1-Gn of the liquid crystal panel assembly 300 to apply a gate signal consisting of a combination of a gate-on voltage Von and a gate-off voltage Voff to the gate lines G1-Gn.

The data driver 500 is connected to data lines D1-Dm of the liquid crystal panel assembly 300, and selects a gray voltage from the gray voltage generator 800 and applies the gray voltage as a data voltage to the data lines D1-Dm. However, when the gray voltage generator 800 provides a reference gray voltage of the limited number instead of providing all gray voltages, the data driver 500 generates a desired data voltage by dividing a reference gray voltage.

The signal controller 600 controls the gate driver 400 and the data driver 500. The signal controller 600 appropriately processes the input video signals R, G, and B to correspond to operation conditions of the liquid crystal panel assembly 300 based on the input video signals R, G, and B and the input control signal CP that are received from the video processor 150, thereby generating a digital video signal DATA, a gate control signal CONT1, and a data control signal CONT2. The signal controller 600 transmits the generated gate control signal CONT1 to the gate driver 400, and transmits a data control signal CONT2 and the processed digital video signal DATA to the data driver 500.

The gate control signal CONT1 includes a scanning start signal STV that instructs the scanning start and at least one clock signal that controls an output period of a gate-on voltage Von. The gate control signal CONT1 may further include an output enable signal OE that limits a duration time of a gate-on voltage Von.

The data control signal CONT2 includes a horizontal synchronization start signal STH that notifies the start of transmitting a digital video signal DATA for pixels PX of a row to the data driver 500, and a load signal LOAD that instructs to apply an analog data voltage to the data lines D1-Dm. The data control signal CONT2 may further include a reversal signal RVS that inverts a polarity of a data voltage with respect to a common voltage Vcom (hereinafter, a “polarity of a data voltage to a common voltage” is abbreviated to a “polarity of a data voltage”).

The data driver 500 generates an analog data voltage by selecting a gray voltage corresponding to the digital video signal DATA and applies the analog data voltage to the corresponding data lines D1-Dm.

The gate driver 400 applies a gate-on voltage Von to the gate lines G1-Gn according to the gate control signal CONT1 from the signal controller 600, thereby turning on a switch Q that is connected to the gate lines G1-Gn. Accordingly, a data voltage that is applied to the data lines D1-Dm is applied to the corresponding pixel PX through the turned on switch Q.

The difference between a data voltage and a common voltage Vcom that are applied to the pixel PX is represented as a charge voltage, i.e., a pixel voltage of a liquid crystal capacitor Clc. Liquid crystal molecules have different arrangements according to a magnitude of a pixel voltage, and thus polarized light of light that passes through the liquid crystal layer changes. The change of the polarized light is represented with a transmittance change of light by a polarizer, and thus a pixel PX displays luminance that is represented by a gray (or a gray level) of a digital video signal DATA.

By repeating such a process using one horizontal period (may be called “1H”, and is the same as a period of a horizontal synchronization signal Hsync and a data enable signal DE) in units, a gate-on voltage Von is sequentially applied to all gate lines G1-Gn and a data voltage is applied to all pixels PX, thereby displaying an image of a frame.

The light emitting device 100 includes a controller 110, a column driver 112, a scan driver 114, and a display unit 116. The controller 110 reads a motion detection signal MD and a brightness information signal LS, and generates a scanning driving control signal CS, a column driving control signal CC, and a light emitting signal CLS. The controller 110 controls a pulse width ratio between a first scan signal and a second scan signal that are applied to a plurality of scan lines S1-Sp according to the motion detection signal MD, and divides a brightness information signal LS into first and second division brightness information signals according to the motion detection signal MD, thereby generating the signals with a light emitting signal CLS. The scanning driving control signal CS includes a scanning start signal that instructs the scanning start to each of a plurality of scan lines S1-Sp and a pulse width control signal that controls at least one clock signal, a first scan signal, and a second scan signal that controls an output period of a scan signal that is applied to each of the plurality of scan lines S1-Sp to have a pulse width corresponding to the motion detection signal MD. For example, when the motion detection signal MD is ‘000’, pulse widths of a first scan signal and a second scan signal have a ratio of 50:50, and when the motion detection signal MD is ‘001’, pulse widths of a first scan signal and a second scan signal have a ratio of 60:40. That is, the controller 110 increases or decreases a pulse width of a first scan signal in units of 10% according to a motion degree of the input video signals R, G, and B based on a still picture.

The column driving control signal CC includes a horizontal synchronization start signal that notifies the start of transmitting a light emitting signal CLS to the column driver 112 to light emitting pixels EPX of a row, and a load signal that instructs the application of a light emitting data voltage according to the light emitting signal CLS to a plurality of column lines C1-Cq. The controller 110 divides a plurality of brightness information data into first division brightness information data and second division brightness information data according to the motion detection signal MD. For example, when the motion detection signal MD is ‘000’, the first division brightness information data and the second division brightness information data are divided into a ratio of 50:50, and when the motion detection signal MD is ‘001’, the first division brightness information data and the second division brightness information data are divided into a ratio of 60:40. When the motion detection signal MD is ‘110’, the first division brightness information data are substantially identical to brightness information data, and a ratio between the first division brightness information data and the second division brightness information data is 100:0. In this way, a ratio between the first division brightness information data and the second division information data is determined to be substantially identical to a pulse width ratio between the first scan signal and the second scan signal. The controller 110 generates the first division brightness information data and the second division information data that are generated according to a determined ratio with a light emitting signal CLS.

The column driver 112 is connected to a plurality of column lines C1-Cq, and controls the light emitting pixel EPX to emit light to correspond to grays (or gray levels) of a plurality of liquid crystal pixels PX corresponding to the light emitting pixel EPX according to a column driving control signal CC and a light emitting signal CLS. Specifically, the column driver 112 determines a pulse width of a plurality of light emitting data voltages according to the light emitting signal CLS, and transfers the pulse width to a plurality of column lines C1-Cq according to the column driving control signal CC. That is, the column driver 112 synchronizes the light emitting pixel EPX to emit light with a certain or predetermined gray (or a certain or predetermined gray level) to correspond to an image that is displayed in a plurality of liquid crystal pixels PX corresponding to one light emitting pixel EPX. The scan driver 114 is connected to a plurality of scan lines S1-Sp, and transfers a plurality of scan signals so that the plurality of light emitting pixels EPX emit light to synchronize with the corresponding plurality of liquid crystal pixels PX, respectively, according to the scanning driving control signal CS.

The display unit 116 includes a plurality of scan lines S1-Sp that transfer a scan signal, and a plurality of column lines C1-Cq and a plurality of light emitting pixels EPX that transfer a light emitting data signal. Each of the plurality of light emitting pixels EPX is positioned at an area that is defined by scan lines S1-Sp and column lines C1-Cq crossing (or intersecting) the scan lines S1-Sp. Each of a plurality of light emitting pixels EPX according to the present exemplary embodiment is formed as a field emission array (hereinafter, referred to as an ‘FEA’) type of electron emission element. The FEA type electron emission element includes an electron emission region and a phosphor layer that are electrically connected to a scan electrode and a data electrode, or at least one of a scan electrode or a data electrode. The electron emission region may be made of a material having a low work function or a large aspect ratio, for example, a carbon-based material and/or a nanometer (nm) sized material. The FEA type electron emission element forms an electric field around the electron emission region using a voltage difference between the scan electrode and the data electrode emits electrons due to the electric field and excites a phosphor layer with the emitted electrons, thereby emitting visible light of intensity corresponding to an electron beam emission amount.

FIG. 3 is a diagram illustrating a scan signal that is supplied to a plurality of scan lines S1-Sp according to an exemplary embodiment, and illustrates a change of a scan signal that is applied to a plurality of scan lines S1-Sp according to a change of the motion detection signal MD in a frame order. In FIG. 3, a horizontal axis is a time axis, and a vertical axis corresponds to a plurality of scan lines S1-Sp. In FIG. 3, each of periods T1 and T2 is divided in units of 1/60 of a second. A period T11 corresponds to a first field of an n-th frame, and a period T12 corresponds to a second field of an n-th frame. For the period T11, a first scan signal is sequentially applied to a plurality of scan lines S1-Sp from a time point P1. A pulse width of the first scan signal changes to correspond to the motion detection signal MD, and FIG. 3 illustrates a case where a motion detection signal MD corresponding to an n-th frame is ‘000’ and a motion detection signal MD corresponding to an (n+1)-th frame is ‘110 ’. Therefore, pulse widths of a first scan signal and a second scan signal of an n-th frame have a ratio of 50:50. A plurality of light emitting data voltages having a pulse width according to a light emitting signal CLS are applied to a plurality of column lines C1-Cq, respectively, to correspond to a first scan signal that is applied to a plurality of scan lines S1-Sp. In this case, the light emitting signal CLS is a signal that is generated according to a plurality of first division brightness information data corresponding to a plurality of light emitting pixels EPX that are connected to the corresponding scan lines S1-Sp. Next, for a period T12, a second scan signal is applied to a plurality of scan lines S1-Sp from a time point P2. A plurality of light emitting data voltages having a pulse width according to the light emitting signal CLS are applied to a plurality of column lines C1-Cq, respectively, to correspond to a second scan signal that is applied to the plurality of scan lines S1-Sp. In this case, the light emitting signal CLS is a signal that is generated according to a plurality of second division brightness information data corresponding to a plurality of light emitting pixels EPX that are connected to the corresponding scan lines S1-Sp. When the motion detection signal MD corresponding to an n-th frame is ‘000’, i.e., when the input video signals R, G, and B are for a still picture, pulse widths of a first scan signal and a second scan signal that are applied to the plurality of scan lines S1-Sp for an n-th frame are substantially identical. Therefore, as a plurality of light emitting pixels EPX continue to emit light for the n-th frame, a flicker phenomenon can be reduced or even prevented.

Next, a period T21 corresponds to a first field of an (n+1)-th frame, and a period T22 corresponds to a second field of an (n+1)-th frame. In the period T21, a first scan signal is sequentially applied to a plurality of scan lines S1-Sp from a time point P3. Because the motion detection signal MD corresponding to an (n+1)-th frame is ‘110 ’, a pulse width ratio of a first scan signal of an (n+1)-th frame becomes 100%. Therefore, a first scan signal is applied to a plurality of scan lines S1-Sp in an (n+1)-th frame. A plurality of light emitting data voltages having a pulse width according to a light emitting signal CLS are applied to a plurality of column lines C1-Cq, respectively, to correspond to a first scan signal that is applied to the plurality of scan lines S1-Sp. In this case, the light emitting signal CLS is a signal that is generated according to a plurality of first division brightness information data corresponding to a plurality of light emitting pixels EPX that are connected to the corresponding scan lines S1-Sp. When the motion detection signal MD corresponding to an (n+1)-th frame is ‘110 ’, i.e., when the input video signals R, G, and B are for a motion picture having a maximum motion, only a first scan signal is applied to a plurality of scan lines S1-Sp for an (n+1)-th frame. Therefore, only at an initial stage of an (n+1)-th frame, a plurality of light emitting pixels EPX emit light, thereby reducing or even preventing a motion blur phenomenon. Further, if the input video signals R, G, and B are for a motion picture having a partial motion and a pulse width of a first scan signal increases by 10% or greater than that of a second scan signal, thereby adjusting a light emitting period of a plurality of light emitting pixels EPX according to a motion degree.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emitting device configured as a light source for a display device configured to display an image according to an input video signal and an input image control signal, the light emitting device comprising:
a display unit comprising a plurality of scan lines, a plurality of column lines crossing the plurality of scan lines, and a plurality of light emitting pixels at crossing regions of the plurality of scan lines and the plurality of column lines and configured to provide light to at least one pixel of the display device;
a partial brightness controller configured to read the input video signal and the input image control signal, to generate a brightness information signal having brightness information of each of the plurality of light emitting pixels, and to generate a motion detection signal having motion information of the entire display device for a frame; and
a controller configured to control a pulse width ratio between a first scan signal and a second scan signal, applied to each of the plurality of scan lines for the frame, according to the motion detection signal.

2. The light emitting device of claim 1, wherein the partial brightness controller is configured to generate the motion detection signal with different values according to whether the input video signal is for a still picture or a motion picture.

3. The light emitting device of claim 2, wherein the partial brightness controller is configured to generate the motion detection signal with different values according to a motion degree of the motion picture when the input video signal is for the motion picture.

4. The light emitting device of claim 2, wherein the controller is configured to control a pulse width of the first scan signal to be substantially identical to a pulse width of the second scan signal when the input video signal is for the still picture.

5. The light emitting device of claim 2, wherein the controller is configured to control a pulse width of the first scan signal to be larger than a pulse width of the second scan signal when the input video signal is for the motion picture.

6. The light emitting device of claim 5, wherein the controller is configured to control the pulse width of the first scan signal to sequentially increase according to a motion degree of the motion picture.

7. The light emitting device of claim 1, wherein the controller is configured to divide the brightness information signal into a first division brightness information signal and a second division brightness information signal according to the motion detection signal, and to generate a light emitting signal.

8. The light emitting device of claim 7, wherein the controller is configured to control a division ratio between the first and second division brightness information signals to be substantially identical to the pulse width ratio between the first and second scan signals.

9. A method of driving a light emitting device comprising a plurality of light emitting pixels, a plurality of scan lines, and a plurality of column lines, the light emitting device being configured as a light source for at least one pixel of a display device for displaying an image according to an input video signal and an input image control signal, the method comprising:
generating a motion detection signal having motion information of the entire display device for a frame;
controlling a pulse width ratio between a first scan signal and a second scan signal according to the motion detection signal; and
applying the controlled pulse width ratio between the first and second scan signals to each of the plurality of scan lines for the frame.

10. The method of claim 9, wherein the generating of the motion detection signal comprises generating the motion detection signal with different values according to whether the input video signal is for a still picture or a motion picture.

11. The method of claim 10, wherein the generating of the motion detection signal comprises generating, when the input video signal is for the motion picture, the motion detection signal with different values according to a motion degree of the motion picture.

12. The method of claim 10, wherein the controlling of the pulse width ratio between the first and second scan signals comprises forming a pulse width ratio of the first scan signal to be substantially identical to the second scan signal when the input video signal is for the still picture.

13. The method of claim 10, wherein the controlling of the pulse width ratio between the first and second scan signals comprises increasing a pulse width of the first scan signal to be larger than that of the second scan signal when the input video signal is for the motion picture.

14. The method of claim 13, wherein the controlling of the pulse width ratio between the first and second scan signals comprises sequentially increasing the pulse width of the first scan signal according to a motion degree of the motion picture.

15. The method of claim 9, further comprising:
generating a brightness information signal having brightness information of each of the plurality of light emitting pixels by reading the input video signal and the input image control signal; and
dividing the brightness information signal into a first divisional brightness information signal and a second division brightness information signal according to the motion detection signal.

16. The method of claim 15, wherein the dividing of the brightness information signal into the first and second division brightness information signals comprises forming a division ratio between the first and second division brightness information signals to be substantially identical to the pulse width ratio between the first and second scan signals.
